(19) United States
(12) Patent Application Publication
(10) Pub. No.: US 2006/0090079 A1
(43) Pub. Date: Apr. 27, 2006

(54) Voice authenticated alarm exit and entry interface system

(75) Inventors: Eric Oh, Brooklyn, NY (US); Kenneth L. Addy, Massapequa, NY (US); Kenneth G. Eskildsen, Great Neck, NY (US)

Correspondence Address: Honeywell Law Department;Patent Services, 101 Columbia Road, AB-2, P.O. Box 2245, Morristown, NJ, 07962-2245, US

(73) Assignee: HONEYWELL INTERNATIONAL, INC., MORRISTOWN, NJ (US)

(21) Appl. No.: 10/970,198

(22) Filed: Oct. 21, 2004

(51) Int. Cl. H04K 1/00

(52) U.S. Cl. 713/186

(57) ABSTRACT

A security system includes biometric authentication such as voice authentication with wireless tag detection to identify both the user and a wireless tag carried by the user. When the user approaches the entrance to a building that is secured by the security system, a tag detector of a user interface receives an identifier from the tag. The user interface transmits the tag identifier to a base station for comparison to pre-stored tag identifiers in a database. If there is a match, the user is prompted to provide a biometric input, such as by speaking a pre-arranged phrase. The biometric input is compared with templates stored in the database to determine if there is a match. If there is a match, the security system is disarmed. The template can be selected based on the tag identifier to improve processing speed.

### BACKGROUND OF THE INVENTION

1. Field of Invention

The present invention relates generally to the field of security systems that require a remote or local keypad or other user interface for the activation or deactivation of the security system. Further, the present invention relates to security systems that use voice or other biometric activation technology to aid in the secure activation and deactivation of the security system.

2. Description of Related Art

Currently available wireless security systems for commercial or home use typically include a hardwired or wireless keypad, an alarm base station and an alarm siren in addition to various additional optional hardware features. Due to the increasing complexity of security systems, a need has arisen to simplify the efforts a human user has to employ in order to control the security system. Examples of technologies that have been implemented within security systems to simplify operations for the user include voice authentication, short-range active RF wireless tags and passive proximity tags.

However, the above-mentioned technologies, even though implemented to simplify the operations of security systems, have several performance disadvantages. For example, voice or other biometric authentication technologies, while presenting a simple user interface for the activation and deactivation of a security system, may not be sufficient by themselves to ensure adequate security. Wireless tags (active RF and passive proximity) have the advantage of low cost, hands free operation and functional reliability. However, wireless tags provide significant security breach issues if the wireless tag is either lost or stolen, in which case the security system enabled with wireless tag technology will only validate the wireless tag and not the potentially unauthorized individual who possesses the tag.

### BRIEF SUMMARY OF THE INVENTION

The present invention addresses the above and other issues by providing a security system wherein the user is provided with a simple biometric interface in addition to having the added protection of wireless tag technology. In particular, the present invention relates to a system and method for providing a biometric authenticated entry and exit interface of a security system situated within a home or business environment. The system uses a combination of biometric authenticating technology and wireless tag technology. Through the leveraging of the two independent technologies into a unique configuration, the assets of the respective technologies can be used to overcome any security concerns that may arise when the technologies are implemented individually.

The invention can be implemented in various ways. In one approach, a voice command and a wireless tag are used to authenticate entry/exit via a user interface. In another approach, a wireless tag such as an RFID tag, or a voice command, is used to wake up a user interface from a sleep state. In another approach, the wireless tag is used to identify the user and reduce the searching time for a matching voice or other biometric template. The combination of voice authentication and the use of a wireless tag, for example, provide a true hands-free reliable interface. Other biometric authentication technologies such as facial recognition and fingerprint recognition in combination with the wireless tag are also valuable in identifying a user, but are not necessarily hands free and may not allow the user to enter commands. However, such non-voice authentication technologies tend to be more reliable than voice inputs.

A biometric security system according to the invention includes a detector for detecting an identifier of a wireless tag carried by a user, a biometric user interface for obtaining biometric data of the user, at least one database for storing at least one tag identifier and at least one biometric template, and at least one processor for verifying an identity of the user by determining whether the detected identifier matches the at least one tag identifier, and whether the biometric data matches the at least one biometric template. The at least one processor controls the security system by at least one of arming and disarming the security system if the identity of the user is verified.

A corresponding method is also provided.

### BRIEF DESCRIPTION OF THE DRAWINGS

These and other features, benefits and advantages of the present invention will become apparent by reference to the following text and figures, with like reference numbers referring to like structures across the views, wherein:

FIG. 1 illustrates an example of a biometric user interface and base station in a secured building, where the biometric user interface detects a wireless tag carried by a user;

FIG. 2 illustrates an example of a biometric user interface according to the invention;

FIG. 3 illustrates an example block diagram of a biometric user interface and base station according to the invention, where the biometric data processing occurs in the base station;

FIG. 4 illustrates an example block diagram of a biometric user interface and base station according to the invention, where the biometric data processing occurs in the biometric user interface;

FIG. 5 illustrates an example method for arming or disarming a base station in a security system according to the invention; and

FIG. 6 illustrates an example method for training a security system to recognize a user according to the invention.

### DETAILED DESCRIPTION OF THE INVENTION

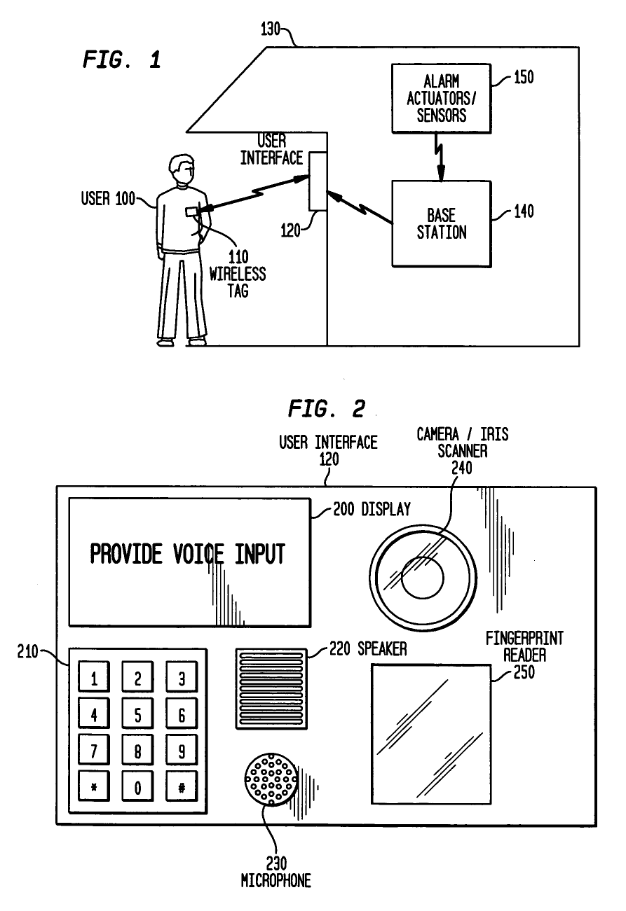

FIG. 1 illustrates an example of a biometric user interface and base station in a secured building, where the biometric user interface detects a wireless tag carried by a user. Many homes and businesses today are equipped with security systems to deter burglaries and detect fires or other hazards, and to control access to different rooms in a building, for example. A security system typically includes a central base station, e.g., control panel, 140, which communicates with a number of peripheral sensors and actuators 150 via a wired or wireless path to secure a building 130. For example, the base station 140 may receive signals from motion, window and door sensors that detect when a person enters a room, or opens a window or door, respectively. Other components such as panic alarms and medical monitoring devices may also communicate with the base station 140. Signals received from fire sensors, such as smoke or heat sensors, indicate that a fire has been detected. When an alarm condition is detected, such as an intrusion or fire, the base station 140 activates components such as a siren and a telephone dialer that dials a remote call center. An operator at the call center takes an appropriate action such as verifying the alarm condition, if possible, and notifying the local police or fire department. Other actuators, such as automatic door locking and unlocking mechanisms, lights or other components in a home network, and machinery or other equipment, may also be controlled.

The base station 140 is typically a larger component that can be located in an unobtrusive location in a home, such as a closet or basement. For convenience, one or more peripheral user interfaces 120 can be provided that communicate with the base station 140 via a wired or wireless path. Wireless components, which typically communicate by RF signals, are gaining popularity because they are more easily installed. For example, a user interface 120 can be located near the entrance to the building 130.

In the example shown, the user 100 approaches the building 130 when the user desires to enter the building 130. The user carries a wireless tag 110. The tag can be provided, e.g., in a key fob or badge, and carried, including worn, by the user. Using proximity detecting technology (e.g., RF active tags, proximity passive tags), the user interface 120 detects the presence of the tag 110, e.g., within a few feet away from the user interface 120. Optionally, to avoid excessive RF activity and power consumption, the user interface 120 and/or detector 305 can be programmed to enter a sleep mode wherein power consumption is minimized. The user interface 120 and/or detector 305 can then be woken up from the sleep state when an input such as a voice command, or the presence of a wireless tag, is detected. This voice command need not be a specified, verified command but can simply be any spoken phrase or noise that denotes that a user desires to access the user interface 120. Likewise, the tag 110 can assume a sleep mode. In this case, when the user speaks into the user interface 120, the user interface 120 wakes up and begins transmitting a signal to wake up the wireless tag 110. When the wireless tag 110 is awoken, it transmits its identifier for a specified amount of time, then returns to the sleep mode. It is also possible to provide sensors, such as motion sensors, that detect when a user is standing near the user interface 120, to initiate a wake up of the user interface 120.

The user interface 120 obtains the identifier (ID) from the tag and determines whether the tag ID is recognized by the security system. For example, during a training procedure, one or more wireless tag IDs are stored by the security system and, optionally, associated with specific users, such as by their name or employee number. Note that various security protocols may be implemented where specific users are allowed to access only certain portions of a building, such as rooms or floors. This information can be setup during the training procedure to provide a further hurdle to be overcome before the user is granted access to a secured area or item. Moreover, the user need not be identified uniquely but may be identified as belonging to a class of users. Different classes of users can be granted different levels of access.

If the tag ID is recognized by the security system, the user interface 120 prompts the user 100 to provide a biometric input, such as a voice command, fingerprint, iris scan, facial recognition input, or DNA input, e.g., from saliva, sweat or hair. The security system then processes the biometric input by determining whether it matches a previously stored biometric input from the particular user 100. The previously stored biometric input may have been obtained during the above-mentioned training procedure. If there is a match, then the security system is controlled to take a predetermined action such as disarming, thereby allowing the user to enter the building 130 without triggering an alarm. Moreover, when a voice input is used, the action taken can be set based on the specific command given, e.g., “arm,” “disarm”, “bypass” or the like. Thus, the same voice input can serve the dual purpose of identifying the user and providing a command to the security system.

FIG. 2 illustrates an example of a biometric user interface according to the invention. The user interface 120 includes a display 200 and speaker 220 for providing prompts or other instructions or information to the user. A keypad 210 may be provided for receiving a pass code input from a user, or instructions from a system administrator, for instance. Physical keys or a touch screen image of keys may be provided, for instance. A microphone 230 receives a voice input from the user, while a camera/iris scanner 240 obtains an image of the user's face or iris, for example, and a fingerprint reader 250 obtains an image of the user's finger. The components 230, 240 and 250 therefore are biometric input devices. Generally, biometrics is the science of measuring an individual's physical properties. Other biometric traits that may be measured include signature, hand and finger geometry, gait, vein structure on the back of the hand, ear form, and odor. Biometric traits other than voice are referred to as non-voice biometric traits. The invention may be used with one or more of these or other biometric input devices. Moreover, the biometric input devices need not be integrated into a common housing of the user interface 120 as shown, but may be provided as separate components that communicate their obtained data to a processor of the user interface 120 by wired or wireless communication paths.

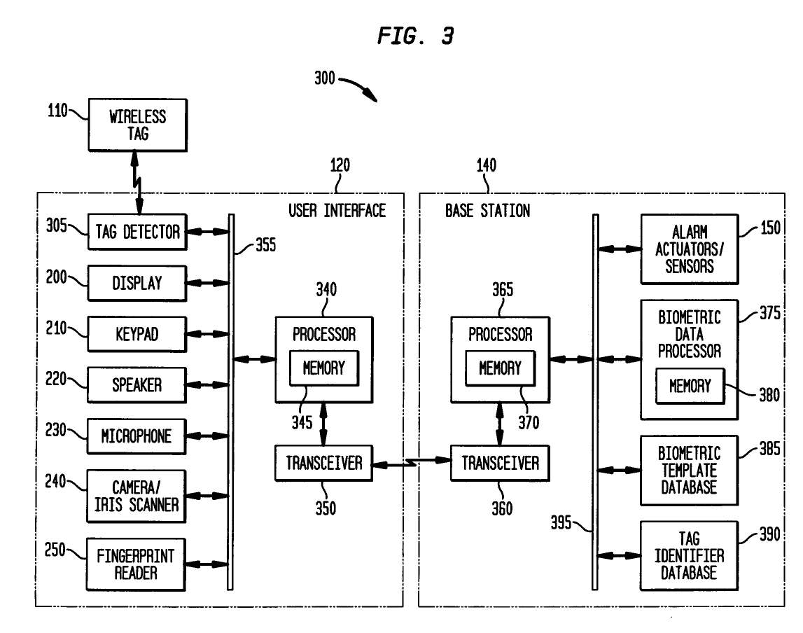

FIG. 3 illustrates an example block diagram of a biometric user interface and base station according to the invention, where the biometric data processing occurs in the base station. The user interface 120 includes a tag detector 305 for communicating with the wireless tag 110 that is carried by the user. Optionally, the tag detector 305 is separate from the user interface 120, and communicates its obtained data to a 340 processor of the user interface 120 by wired or wireless communication paths. In one possible configuration, the tag detector 305, display 200, keypad 210, speaker 220, microphone 230, camera/iris scanner 240 and fingerprint reader 250 communicate with a central processor, e.g., control, 340 of the user interface 120 via a bus 355. The processor 340 may manage the overall functioning of the user interface 120 as well as the communication of data with the base station 140 via a transceiver 350. The processor 340 includes a memory 345 that may store software instructions, including software, firmware and/or micro-code, for execution to achieve the functionality described herein. Such a memory resource, and other memory resources discussed herein, may be considered to be program storage devices. The tag detector 305, display 200, keypad 210, speaker 220, microphone 230, camera/iris scanner 240 and fingerprint reader 250 may include separate processing and memory resources as needed. A power source such as a battery may be used to power the components of the user interface 120.

The base station 140 includes a processor, e.g., control, 365 with memory 370 for controlling the overall functioning of the base station 140 as well as the communication of data with the user interface 120 via a transceiver 360. The alarm actuators/sensors 150, along with a biometric data processor 375, including memory 380, a biometric template database 385, and a tag identifier database 390 communicate with the processor 365 via a bus 395, in one possible configuration. The term “database” is meant to encompass any type of data storage resource, regardless of how configured or organized. The biometric template database 385 stores one or more templates of biometric data provided by one or more users, such as during a training procedure, where a user is prompted to provide a biometric input, e.g., by speaking a word or phrase into the microphone 230. The electrical signal from the microphone 230 is digitized by an analog-to-digital (A/D) converter and communicated to the base station 140 for storage in the biometric template database 385.

The biometric data processor 375 executes software instructions stored in the memory 380 to compare biometric data obtained from a user via the user interface 120 to one or more of the templates stored in the biometric template database 385, e.g., using a template matching process. The tag identifier database 390 stores one or more identifiers of wireless tags, e.g., that are obtained by the tag detector 305. The tag identifiers may be indexed to identifiers of respective users to provide the capability to identify a specific user by a specific tag identifier. Likewise, the templates stored in the biometric template database 385 may be indexed by tag identifier and/or user identifier to identify a specific template based on a specific tag or user identifier. Note that the biometric data processor 375, biometric template database 385, and the tag identifier database 390 are shown as being separate for explanation purpose. The functionality described may be provided by any arrangement of processing and storage resources.

Referring again to the user interface 120, the tag detector 305 may periodically emit a signal that is received by the wireless tag 110 when it is within range of the tag detector 305. The wireless tag 110 responds by transmitting a signal that is encoded with its identifier, such as a sequence of bits that corresponds to a string of letters and/or numbers. The tag detector 305 receives the signal and recovers the identifier. The identifier is then communicated from the tag detector 305 to the processor 340, via the bus 355, and to the transceiver 350. The transceiver 350 transmits a wireless signal to the corresponding transceiver 360 of the base station 140. The tag identifier is recovered by the processor 365, which in turn compares the identifier to the previously-stored identifiers in the tag identifier database 390. Comparison of the wireless tag identifier is computationally easy as it typically involves only comparing a string of a few letters or numbers. If there is a match, then it is known that the tag identifier has previously been learned into the security system 300, in which case the processor 365 sends a command to the user interface 120 to instruct it to prompt the user for a biometric input, e.g., using a recorded or synthesized voice message that is reproduced by the speaker 220, and/or a message on the display 200, such as “Provide voice input.” One or more of the various biometric input devices 230, 240 and 250 receive biometric data of the user and communicate it to the base station 140, via the processor 340 and transceiver 350.

At the base station 140, the processor 365 provides the biometric data to the biometric data processor 375, and instructs the biometric template database 385 to locate the template that is associated with the particular user identifier or tag identifier for which a match was previously found. The template is then provided to the biometric data processor 375, where a template matching process is carried out to determine if the template matches the input biometric data. The term “match” in this context does not necessarily require an exact match with 100% confidence. The match should provide a sufficient degree of confidence that the template and the input biometric data are from the same person. The biometric data processor 375 informs the processor 365 of whether or not there is a match. If there is no match, the processor 365 may take an action such as alerting security personnel, or simply recording the information provided by the user, and flagging it for later review by a system administrator. Or, the user may be requested to provide a repeat of the same biometric input, or a different type of biometric input. If there is a match, the identity of the user has been verified, and the processor 365 may take a predetermined action such as arming or disarming the security system, or unlocking or locking a door, for example.

Note that, according to the invention, by comparing the input biometric data to a selected template that is expected to match because it was selected based on the wireless tag carried by the user, the processing burden is significantly reduced relative to the case where the input biometric data must be compared to multiple templates to determine which template matches. Furthermore, even when the tag identifier is associated with a group of users rather than a specific user, the number of templates that must be compared is reduced according to the size of the group relative to the population of all possible users.

As indicated, the user interface 120 may be located at the entrance and/or exit to a building, for example, while the base station may be in a secured room inside the building. This approach is convenient since typically more than one user interface may be used which communicates with a common base station 140. Moreover, some of the processing functions can be carried out in the base station 140, thereby allowing the size and cost of the user interfaces 140 to be reduced. However, generally, the functionality carried out by the user interface 120 and base station 140 can be combined into one or more components. For example, a single combined user interface and base station may be used.

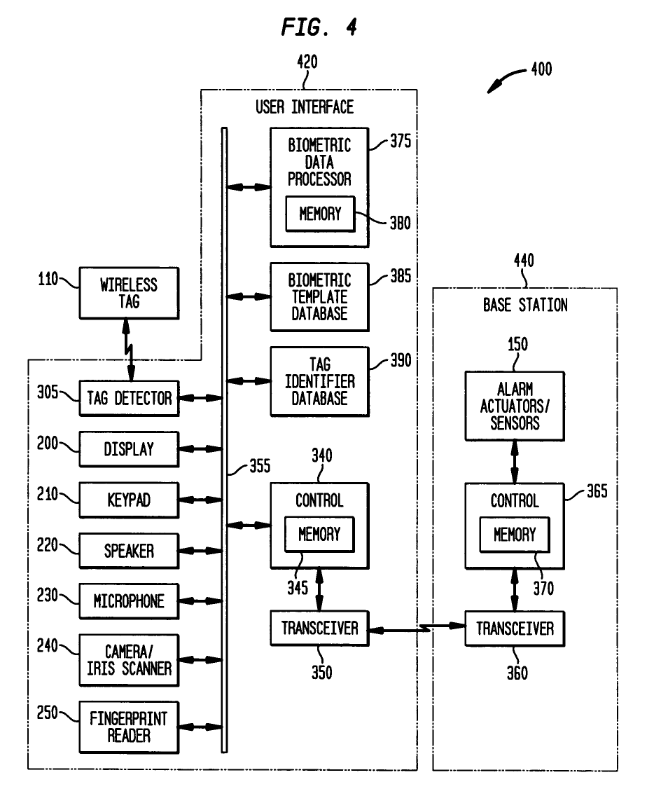

FIG. 4 illustrates an example block diagram of a biometric user interface and base station in a security system 400 according to the invention, where the biometric data processing occurs in the biometric user interface. In this configuration, the biometric data processor 375 with memory 380, biometric template database 385, and tag identifier database 390 are provided in the user interface 420 rather than in the base station 440. This approach frees the base station 440 from performing the biometric processing and facilitates integration of the invention into existing security systems since a pre-existing base station can be used with only software modifications. In contrast, having the biometric data processing occur in the base station can reduce costs since the processing components are not duplicated in each user interface. Additionally, the same pre-stored tag identifiers and biometric templates are easily accessible to all user interfaces. Moreover, the base station can often be provided in a more secure location than the user interfaces, resulting in greater security.

The present invention will be described below in relation to a user's exit and entry from a building such as a home or business location, in which automatic arming and disarming of the security system is achieved.

### Entry Scenario

In an example entry scenario, a user approaches the secured building 130 (FIG. 1) wherein at least one user interface 120 is situated at an entryway. The base station 140 is armed and, upon detecting an alarm condition such as an intrusion, has the capability to generate an alarm signal. The user 100 can be a person desiring to enter the secured building or other location, such as a homeowner desiring to enter a home, or an employee desiring to enter a place of business. The user, with a wireless tag 110 in her/his possession, approaches the entryway. Upon reaching a predetermined distance from the user interface 120, the tag detector 305 (FIG. 3) detects the wireless tag 110 and causes it to transmit its identifier. Optionally, this does not occur until the user interface 120 is awoken from a sleep state, such as by a voice command or other noise from the user 100. The tag detector 305 receives the tag identifier, and the tag identifier is compared to the identifiers in the tag identifier database 390 for authentication.

The user may be prompted to provide a biometric input immediately upon the detection of the wireless tag 110 by the tag detector 305, or the biometric input may not be requested until after the tag identifier has been matched to an identifier in the tag identifier database 390. The user can be prompted audibly via the speaker 220, and/or visually, via the display 200. For example, the user may provide the biometric input by speaking a disarm confirmation phrase. The spoken phrase is received and transmitted to the base station 140, for instance, for comparison with one or more templates at the biometric data processor 375. The biometric data processor 375 compares the user's voice and the identifier of the wireless tag 110 to a biometric model of the user's voice and wireless tag identifiers, respectively, stored within the databases 385 and 390. Any type of voice-matching software may be used for the comparison.

If the biometric data processor 375 determines that the user's voice matches a voice template, and it is also determined that the detected wireless tag identifier matches a pre-stored wireless tag identifier, then the base alarm station 140 will disarm, thereby allowing the user to enter the building without triggering an alarm. A confirmation message may be provided to the user that the system had been disarmed via the display 200 and/or speaker 220.

In particular, one or more voice models or other biometric templates may be stored for a security system. For example, at a residence, voice models may be stored for persons that are authorized to enter the home. At a business, voice models may be stored for persons that are authorized to enter the business. To set up the system, a phrase, e.g., one or more words, is recorded by each user and stored in the biometric template database 385 as the voice model. This may occur during a training procedure, for instance. The same or different phrases can be spoken by different users. The phrase can be a secret phrase, such as a code word known only to the user, or simply the user's name or employee number, for instance. Moreover, several different phrases can be stored in the biometric template database 385 for a given user, and a different action associated with each phrase, e.g., “arm”, “disarm”, “bypass” and so forth. The voice commands can therefore be carried out when the identity of the user is verified to allow the user to control the security system as well as being recognized by the system.

Further, in setting up the system, the wireless tags 110 may be assigned to specific users, in which case the tag identifier database 390 is configured to associated specific tag identifiers with specific users. During the entry/exit process, a further check can be made to ensure that there is a match between the authenticated confirmation phrase and the tag identifier. In this case, a user who has the wrong tag is not granted access. Or, the wireless tags may be given to different users without regard to the specific identity of the user, in which case the user will be granted access if the tag identifier is recognized and the confirmation phrase is authenticated. In fact, multiple tags having the same identifier may be used with one security system. However, for the highest level of security, the tag identifiers should be specific to specific users. The user can also be required to enter a conventional pass code using keys on the keypad 210 to gain access.

### Exit Scenario

In an exit scenario, it is assumed that a user is positioned inside of the building in which the base station 140 and the user interface 120 are located, and that the base station 140 is disarmed. The user with a wireless tag 110 in her/his possession walks towards an exit, where the user interface 120 is located. When the user is within a predetermined distance of the user interface 120, the tag detector 305 detects the wireless tag 110. Optionally, this does not occur until the user interface 120 and/or tag detector 305 is awoken from a sleep state, such as by a voice command or other noise from the user. The tag detector 305 receives the tag's identifier, which is, in turn, transmitted to the processor 365 for matching with an identifier in the tag identifier database 390.

Upon the detection of the wireless tag 110 by the tag detector 305 of the user interface 120, which may be considered to be remote from the base station 140, the user interface will audibly, via the speaker 220, and/or visually, via the display 200, prompt the user to provide a biometric input such as by speaking an activation phrase into the microphone 230. The user may be prompted to provide the biometric input immediately upon the detection of the wireless tag 110 by the tag detector 305, or the biometric input may not be requested until after the tag identifier has been matched to an identifier in the tag identifier database 390. The activation phrase spoken by the user is received and transmitted to the biometric data processor 375, which attempts to match the spoken activation phrase to a predetermined activation phrase or template that is stored within the biometric template database 385. If the biometric data processor 375 determines that the spoken activation phrase matches a template, then an arming confirmation of the base station 140 is broadcast to the user via the speaker 220 and/or display 200, and the alarm base station 140 is armed. Thus, the security system is automatically armed when the user exits the building.

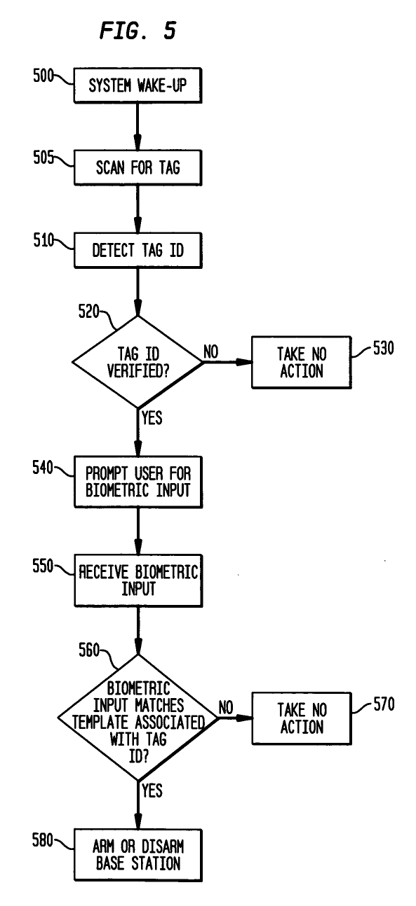

FIG. 5 illustrates an example method for arming or disarming a base station in a security system according to the invention. At block 500, the system is woken up from a sleep state such as by the user speaking. At block 505, the tag detector 305 of the user interface 120 scans an area such as near the entrance or exit of a building to determine if there are any wireless tags present. At block 510, a tag identifier (ID) is detected. At block 520, if the tag ID is verified as matching an identifier in the tag ID database 390, the user is prompted for a biometric input (block 540). If the tag ID is not verified, no action is taken (block 530). Or, an action may be taken such as notifying security personnel or requesting that the user provide an additional biometric input. At block 550, a biometric input is received from the user. At block 560, if the biometric input matches a template that is associated with the tag identifier, or a user identifier associated with the tag identifier, a predetermined action is taken such as arming or disarming the base station (block 580).

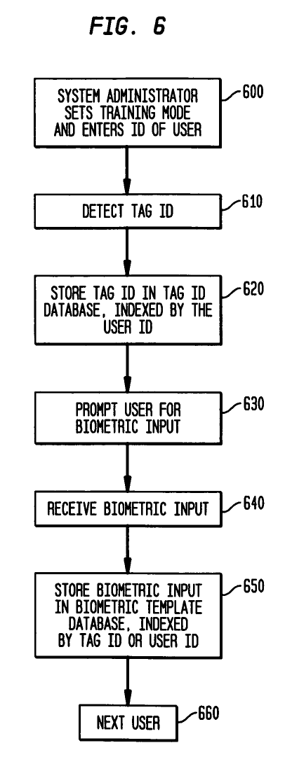

FIG. 6 illustrates an example method for training a security system to recognize a user according to the invention. The training procedure is used generally to setup the security system with tag identifiers and biometric templates. At block 600, a system administrator, e.g., a designated and authorized person such as a security manager in a company, or a parent in a home, sets a training mode in the alarm system and enters an identifier of a user who is to be learned into the system. For example, this may be achieved by entering a pass code on the keypad 210 of the user interface. At block 610, the wireless tag that is to be assigned to the user is placed within range of the tag detector 305 so that the tag identifier can be detected. At block 620, the tag ID is stored in the tag ID database 390 and indexed to the user ID. At block 630, the user is prompted to provide a biometric input. Note that multiple biometric inputs of the same or different types may be input. This gives the user the option of using the most convenient type. For instance, a voice input and a fingerprint input may be provided. In the winter, it may be inconvenient to remove gloves to provide a fingerprint, while other times the user may have a sore throat, which makes it difficult to speak. At block 640, the biometric input is received. At block 650, the biometric input is stored in the biometric template database 385, and indexed by the tag identifier and/or user identifier. At block 660, the next user is processed.

The security system may also be configures to identify security privileges accorded to each user, such as identifiers of the rooms in a building in which the user is authorized to enter. In this way, a user is permitted to enter a room only when the tag identifier, biometric data and security privilege data are in order.

Accordingly, it can be seen that the invention provides a security system with biometric authentication such as voice authentication, and wireless tag detection capabilities, which authenticates both the user and a wireless tag carried by the user. Note that the examples above indicate how the invention may be used to allow a user to enter or exit a building with automatic disarming and arming, respectively, of a security system. However, the invention is suitable generally for controlling access to any secured location or item, such as a safe, cabinet, weapon, or the like.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

What is claimed is:

1. A biometric security system, comprising:
a detector for detecting an identifier of a wireless tag carried by a user;
a biometric user interface for obtaining biometric data of the user;
at least one database for storing at least one tag identifier and at least one biometric template; and
at least one processor for verifying an identity of the user by determining whether the detected identifier matches the at least one tag identifier, and whether the biometric data matches the at least one biometric template;
wherein the at least one processor controls the security system by at least one of arming and disarming the security system if the identity of the user is verified.

2. The biometric security system of claim 1, wherein:
the at least one database stores a plurality of biometric templates; and
the at least one biometric template is selected from the plurality of biometric templates according to the detected identifier.

3. The biometric security system of claim 1, wherein:
the at least one database stores at least one user identifier associated with the at least one tag identifier;
the at least one database stores a plurality of biometric templates; and
the at least one biometric template is selected from the plurality of biometric templates according to the at least one user identifier.

4. The biometric security system of claim 1, wherein:
the biometric user interface includes at least one of a speaker and a display for prompting the user to provide the biometric data responsive to the at least one processor determining that the detected identifier matches the at least one tag identifier.

5. The biometric security system of claim 1, wherein:
the biometric user interface includes at least one of a speaker and a display for providing a confirmation to the user when the identity of the user is confirmed.

6. The biometric security system of claim 1, wherein:
the wireless tag comprises a RF active wireless tag.

7. The biometric security system of claim 1, wherein:
the wireless tag comprises a proximity passive wireless tag.

8. The biometric security system of claim 1, wherein:
the biometric input comprises a voice input.

9. The biometric security system of claim 8, wherein:
the at least one processor carries out a command based on the voice input when the identity of the user is verified.

10. The biometric security system of claim 1, wherein:
the biometric input comprises a non-voice input.

11. The biometric security system of claim 1, further comprising:
a base station configured to receive a signal from at least one sensor that detects when an alarm condition exists in a building; wherein:
the at least one database and the at least one processor are provided in the base station; and
the biometric user interface and the detector are located remotely from the base station.

12. The biometric security system of claim 1, further comprising:
a base station located remotely from the biometric user interface and configured to receive a signal from at least one sensor that detects when an alarm condition exists in a building; wherein:
the at least one processor includes at least a first processor for controlling the security system, and at least a second processor for verifying the identity of the user;
the at least a first processor is provided in the base station; and
the at least a second processor is provided in the biometric user interface.

13. The biometric security system of claim 12, further comprising:
the at least one database is provided in the biometric user interface.

14. The biometric security system of claim 1, wherein:
the detector is configured to enter a sleep state until awaken by a voice command from the user, at which time the detector transmits a signal to the wireless tag, causing the wireless tag to transmit a signal with its identifier.

15. The biometric security system of claim 1, wherein:
the wireless tag is configured to enter a sleep state until awaken by a signal from the detector, at which time the wireless tag transmits a signal with its identifier.

16. The biometric security system of claim 1, wherein:
the biometric user interface is located near an entrance to a building; and
the at least one processor controls the security system by disarming the security system if the identity of the user is verified.

17. The biometric security system of claim 1, wherein:
the biometric user interface is located near an exit to a building; and
the at least one processor controls the security system by arming the security system if the identity of the user is verified.

18. A biometric security system, comprising:
means for detecting an identifier of a wireless tag carried by a user;
means for obtaining biometric data of the user;
means for storing at least one tag identifier and at least one biometric template; and
means for verifying an identity of the user by determining whether the detected identifier matches the at least one tag identifier, and whether the biometric data matches the at least one biometric template;
means, responsive to the verifying means, for controlling the security system by at least one of arming and disarming the security system if the identity of the user is verified.

19. A method for providing a biometric security system, comprising:
detecting an identifier of a wireless tag carried by a user;
obtaining biometric data of the user;
storing at least one tag identifier and at least one biometric template; and
verifying an identity of the user by determining whether the detected identifier matches the at least one tag identifier, and whether the biometric data matches the at least one biometric template; and
responsive to the verifying, controlling the security system by at least one of arming and disarming the security system if the identity of the user is verified.
